(19) United States
(12) Patent Application Publication
(10) Pub. No.: US 2015/0134510 A1
(43) Pub. Date: May 14, 2015

(54) SYSTEMS AND METHODS FOR REPORTING A USER INTERFACE STATUS

(71) Applicant: QUALCOMM Incorporated, San Diego, CA (US)

(72) Inventor: Jeremy O'Donoghue, Wokingham (GB)

(21) Appl. No.: 14/338,159

(22) Filed: Jul. 22, 2014

Related U.S. Application Data
(60) Provisional application No. 61/902,098, filed on Nov. 8, 2013.

(51) Int. Cl. H04W 4/00; G06Q 20/32; G06F 3/048; H04M 1/725

(52) U.S. Cl. CPC H04W 4/008; H04W 4/003; H04M 1/72527; G06Q 20/3278; G06F 3/048; H04W 88/06
USPC 705/39; 455/419; 455/552.1

(57) ABSTRACT

A method for reporting a user interface status by an electronic device is described. The method includes sending a user interface status message from a device host to a controller. The user interface status message indicates an availability of one or more user interfaces. Availability corresponds to a powered state. The method also includes sending application information from one or more secure elements to the controller. The method further includes determining an application list based on the user interface status message and the application information. The method additionally includes sending the application list to a remote device.

### RELATED APPLICATIONS

This application is related to and claims priority from U.S. Provisional Patent Application Ser. No. 61/902,098, filed Nov. 8, 2013, for “Systems and methods for reporting a user interface status.”

### TECHNICAL FIELD

The present disclosure relates generally to electronic devices. More specifically, the present disclosure relates to systems and methods for reporting a user interface status.

### BACKGROUND

The use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., smartphones) transmit wireless signals. For example, the wireless signals may be utilized to communicate with other electronic devices. For instance, the wireless signals may convey voice information or data. In some implementations, the wireless communication may be over an inductive coupling between devices.

However, the use of some wireless technology is currently limited. Some functions and abilities of an electronic device may depend on the status of one or more user interfaces. As can be observed from this discussion, systems and methods for reporting a user interface status may be beneficial.

### SUMMARY

A method for reporting a user interface status by an electronic device is described. The method includes sending a user interface status message from a device host to a controller. The user interface status message indicates an availability of one or more user interfaces. Availability corresponds to a powered state. The method also includes sending application information from one or more secure elements to the controller. The method also includes determining an application list based on the user interface status message and the application information. The method further includes sending the application list to a remote device.

Determining the application list may include listing one or more application indicators corresponding to applications that utilize a user interface that is available. Determining the application list may additionally or alternatively include excluding one or more application indicators corresponding to applications that utilize a user interface that is unavailable.

The method may also include sending a time-to-availability message that indicates a time-to-availability of one or more user interfaces to the remote device. The user interface status message may be sent from the device host to the controller when a status change of the one or more user interfaces occurs.

The controller may be a near-field communication (NFC) controller that includes a proximity payment system environment (PPSE). The PPSE of the NFC controller may determine the application list.

Each of the one or more secure elements may include a PPSE that determine an application list. The controller may update the application list to indicate user interface availability.

An electronic device for reporting a user interface status is also described. The electronic device includes a device host that sends a user interface status message. The user interface status message indicates an availability of one or more user interfaces. Availability corresponds to a powered state. The electronic device also includes at least one secure element that sends application information. The electronic device further includes a controller coupled to the device host and to the at least one secure element. The controller receives the user interface status message from the device host. The controller also receives the application information from the at least one secure element. The controller further determines an application list based on the user interface status message and the application information. The controller additionally sends the application list to a remote device.

A computer-program product for reporting a user interface status is also described. The computer-program product includes a non-transitory tangible computer-readable medium having instructions thereon. The instructions include code for causing an electronic device to send a user interface status message from a device host to a controller. The user interface status message indicates an availability of one or more user interfaces. The availability corresponds to a powered state. The instructions also include code for causing the electronic device to send application information from one or more secure elements to the controller. The instructions further include code for causing the electronic device to determine an application list based on the user interface status message and the application information. The instructions additionally include code for causing the electronic device to send the application list to a remote device.

An apparatus for reporting a user interface status is also described. The apparatus includes means for sending a user interface status message from a device host to a controller. The user interface status message indicates an availability of one or more user interfaces. Availability corresponds to a powered state. The apparatus also includes means for sending application information from one or more secure elements to the controller. The apparatus further includes means for determining an application list based on the user interface status message and the application information. The apparatus additionally includes means for sending the application list to a remote device.

### BRIEF DESCRIPTION OF THE DRAWINGS

FIG. 1 is a block diagram illustrating one configuration of an electronic device in which systems and methods for reporting a user interface status may be implemented;

FIG. 2 is a flow diagram illustrating one configuration of a method for reporting a user interface status by an electronic device;

FIG. 3 is a block diagram illustrating a more specific configuration of an electronic device in which systems and methods for reporting a user interface status may be implemented;

FIG. 4 is a flow diagram illustrating another configuration of a method for reporting a user interface status by an electronic device;

FIG. 5 is a thread diagram illustrating one configuration of timing for reporting a user interface status;

FIG. 6 is a block diagram illustrating another more specific configuration of an electronic device in which systems and methods for reporting a user interface status may be implemented; and

FIG. 7 illustrates various components that may be utilized in an electronic device.

### DETAILED DESCRIPTION

The systems and methods disclosed herein may be applied to communication devices that communicate wirelessly and/or that communicate using a wired connection or link. For example, some communication devices may communicate with other devices using an Ethernet protocol. In another example, some communication devices may communicate with other devices using wireless communication. In one configuration, the systems and methods disclosed herein may be applied to a communication device that communicates with another device using an induction-based communication technology. One implementation of an induction-based communication technology is near-field communication (NFC).

The systems and methods described herein enable reporting of a user interface (UI) status. For example, an improved method for reporting UI availability by a near-field communication (NFC) controller is presented.

In some configurations, an NFC-enabled device (e.g., handset, smartphone, etc.) may include one or more secure elements. Applications on a secure element may utilize information indicating whether there is a user interface (e.g., a display and/or keypad, etc.) available for use. This information may be returned in an entity called the proximity payment system environment (PPSE), which resides in a secure element in some implementations.

In some NFC payment implementations, there are tight timing requirements for payment transactions. For example, a payment transaction may be required to complete in less than 250 milliseconds (ms) if no user interaction is needed. However, this may be challenging in a smartphone environment since a smartphone may spend much of its time powered down, in a low-power or in a sleep state. In some implementations, heuristics may be used to determine the availability of a UI. For example, the availability of a UI may be inferred by considering battery voltage or by an implicit determination of availability according to the availability of a communication channel to the device host.

In some configurations of the systems and methods disclosed herein, the PPSE functionality may be incorporated into the NFC controller. Additionally, messages may be communicated between the NFC controller and the smartphone operating system to allow the smartphone to report on its UI status. Advantageously, as the entity that hosts the PPSE, it is straightforward for the NFC controller to update reporting of the UI state in the PPSE. In yet another configuration, for devices that do not host an entire PPSE or where legacy secure elements are used that do not support an external PPSE, the NFC controller can update the specific bits in the PPSE that relate to UI availability when reporting these to a remote device (e.g., contactless reader).

Various configurations are now described with reference to the Figures. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

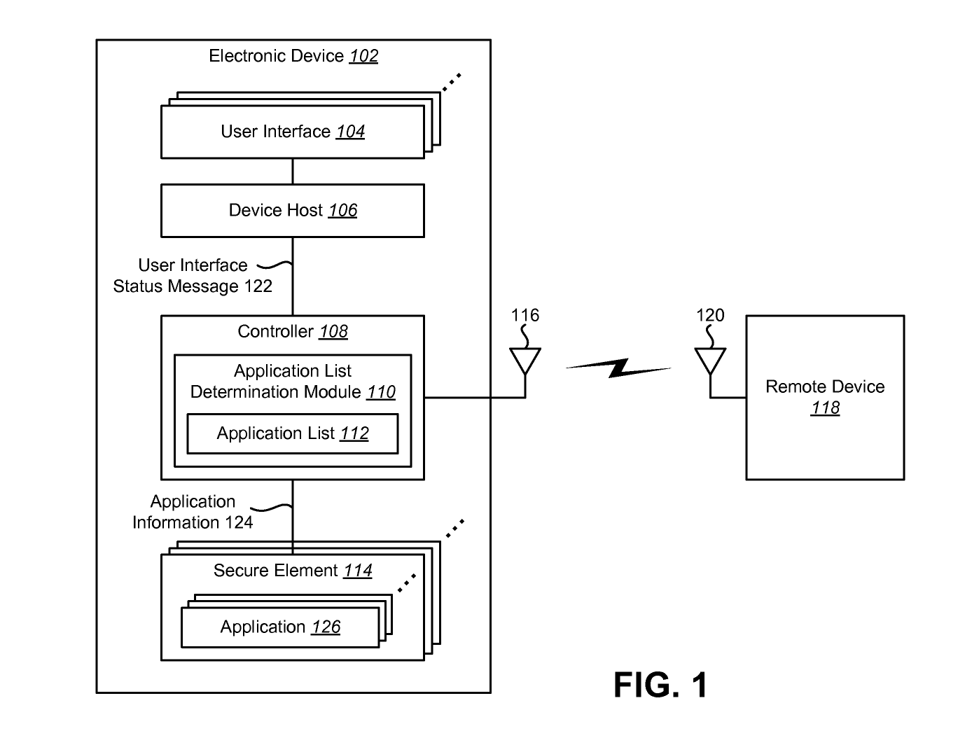

FIG. 1 is a block diagram illustrating one configuration of an electronic device 102 in which systems and methods for reporting a user interface 104 status may be implemented. Examples of the electronic device 102 include cellular phones, smartphones, tablet devices, voice recorders, digital cameras, still cameras, camcorders, gaming systems, laptop computers, etc. The electronic device 102 includes one or more user interfaces 104, a device host 106, a controller 108 and one or more secure elements 114. Each component of the electronic device 102 may be implemented in hardware (e.g., circuitry) or a combination of hardware and software (e.g., a processor with executable instructions stored in memory).

Each of the one or more user interfaces 104 may be a device that enables a user to interact with the electronic device 102. Examples of user interfaces 104 include but are not limited to displays, touch sensors, touch screens, keypads, buttons, cameras, microphones, fingerprint readers, speakers, etc.

A user interface 104 may operate in accordance with one or more states. One state may be a power state, which may include whether the user interface 104 is powered on or powered off. Another state may be an accessibility state, which may include whether the user interface 104 is locked/unlocked, etc. A user interface 104 may be in an active state (e.g., available for user interaction) or an inactive state (e.g., not available for user interaction). For example, a display may display content while in an active state. Similarly, a camera may capture images, a microphone may capture sound, a touch screen may detect a contact and a fingerprint reader may read a fingerprint while in active states. However, one or more of the user interfaces 104 may be deactivated and/or may only provide reduced operation in other states. For example, a display, a touch screen, a keypad, a camera, a microphone and/or a fingerprint reader may be deactivated while in an inactive state.

Each of the user interfaces 104 may exhibit a time-to-availability depending on their current state. For example, if a user interface 104 is in an active state, its time-to-availability may be 0 (e.g., it may be immediately available). However, if a user interface 104 is in an inactive state, the time-to-availability may be some amount of time required for activation. In other words, if a user interface 104 is in an inactive state, the time-to-availability for the user interface 104 may be the time it takes the user interface 104 to transition from an inactive state to an active state.

The user interface(s) 104 may be coupled to the device host 106. As used herein, the term “coupled” and variations thereof may mean that two or more components are directly or indirectly connected. For example, a user interface 104 may be directly connected to the device host 106 (without any intervening components) or may be indirectly connected to the device host 106 (via one or more intervening components). In the block diagrams included herein, lines or arrows between components may denote couplings.

The device host 106 may generally perform operations on the electronic device 102. One example of the device host 106 includes a processor and memory, where the processor runs an operating system (OS). Examples of operating systems that may be run by the device host 106 include Android, iOS, Windows Phone, Windows RT and Blackberry.

The device host 106 may operate in accordance with several states. For example, the device host 106 may run programs while in an active state. However, the device host 106 may be deactivated and/or may only allow reduced activity (e.g., processing) in other states. For example, the device host 106 may only allow limited functionality when in a locked state. In some configurations, the states of one or more user interfaces 104 may depend on the device host 106 (and vice-versa). For instance, if a camera requires processing by the device host 106 (e.g., for facial recognition, iris scanning, etc.), the camera's state may depend on whether the device host 106 is available for processing.

The device host 106 may be coupled to the controller 108. The controller 108 may be implemented in hardware or a combination of hardware and software. Examples of the controller 108 include electronic circuitry, application-specific integrated circuits (ASICs), processors and memory that store executable instructions (that may be separate from a processor/memory utilized for the device host 106, for example), etc. In some configurations, the controller 108 may be included in (or may be one implementation of) an induction-based communication transceiver, which may establish radio communication with a remote device 118 using magnetic induction. The induction-based communication transceiver may include an induction-based transmitter and a receiver. One specific example of induction-based communication is near-field communication (NFC). Therefore, in some configurations, the controller 108 may be an NFC controller that operates according to NFC protocols.

In some configurations, the controller 108 may include a proximity payment system environment (PPSE). The PPSE may be a program, software or instructions that may be run by the controller 108 in order to perform one or more functions (e.g., to indicate the capability of the applications available on the device 102, to enable credit card transactions, etc.).

The controller 108 may be coupled to an antenna 116. The antenna 116 may enable the controller 108 to communicate with other devices. In some configurations, the antenna 116 may be an induction-based loop antenna. As illustrated in FIG. 1, the controller 108 may wirelessly communicate with a remote device 118. Examples of remote devices 118 include card readers (e.g., NFC card readers), smartphones, scanners, electronic locks and other electronic devices.

The controller 108 may also be coupled to one or more secure elements 114. A secure element 114 may be implemented in hardware or a combination of hardware and software. Each of the secure element(s) 114 may be, for example, an electronic circuit, a system on a chip (SoC), an ASIC, a microprocessor with instructions and/or a subscriber identity module (SIM) card, etc. One or more of the secure elements 114 may be removable from the electronic device 102. Additionally or alternatively, one or more of the secure elements 114 may be attached (e.g., soldered) and non-removable from the electronic device 102. One or more of the secure elements 114 may be operable independent of the device host 106. For example, the secure element(s) 114 may be capable of operating even while the device host 106 (e.g., the OS) is inactive.

Each of the secure elements 114 may include one or more applications 126. The applications 126 may perform one or more functions when executed. For example, the applications 126 may enable certain transactions or functions (e.g., debit card payments, credit card payments, authentication, etc.). One function that may be performed by an application 126 is authentication. Authentication may be based on the input of a personal identification number (PIN), password, contact pattern (e.g., a spatial pattern of swipes and/or points of contact on a touchscreen), image recognition (e.g., facial recognition, iris recognition, etc.), biometrics (e.g., fingerprint recognition, iris scan, etc.), sound recognition (e.g., voice recognition, spoken password) and/or combinations thereof, for example.

One or more of the applications 126 may utilize one or more of the user interfaces 104 to function. For example, a credit card payment application 126 may utilize a camera, touchscreen, keypad, fingerprint reader and/or microphone to authenticate a user. Accordingly, one or more of the applications 126 included on the secure element(s) 114 may not be fully operable when a user interface 104 utilized by the application 126 is inactive.

The device host 106 may send a user interface status message 122 to the controller 108. The controller 108 may receive and/or update the user interface status message 122. For example, the controller 108 may maintain one or more user interface 104 state indicators in memory (e.g., in a cache). The user interface status message 122 may indicate the availability of one or more of the user interfaces 104. For example, the user interface status message 122 may indicate whether one or more display(s), touch sensor(s), touch screen(s), keypad(s), button(s), camera(s), microphone(s), fingerprint reader(s) and/or speaker(s) are in an active state, an inactive state (e.g., sleep or doze mode where the user interface 104 consumes low power but is available with a short delay), a locked state, a dimmed state (where a display or touch screen is operating at reduced brightness, for example) or another state. Therefore, the user interface status message 122 may inform the controller 108 of the availability of one or more of the user interfaces 104.

It should be noted that the user interface status message 122 may indicate the availability of one or more (e.g., groups) of the user interfaces 104. For example, a single user interface status message 122 may be sent to indicate the state of a single user interface 104 or a single user interface status message 122 may be sent to indicate the states of multiple user interfaces 104. In some cases, the user interface status message 122 may indicate that one or more user interfaces 104 may be unavailable indefinitely (e.g., when the electronic device 102 is low on battery power).

In some configurations, the user interface status message 122 may also indicate a time-to-availability for one or more of the user interfaces 104. Additionally or alternatively, one or more times-to-availability corresponding to the user interface(s) 104 may be predetermined and stored by the controller 108. Accordingly, the controller 108 may determine a time-to-availability corresponding to a particular user interface 104 based on the current state of that user interface 104. It should be noted that time-to-availability may be further based on the state of the device host 106 in some configurations. For example, if the device host 106 is in an inactive mode, the time-to-availability for a particular user interface 104 may be the time required to activate the device host 106 and that user interface 104. In one configuration, the time-to-availability for one or more of the user interfaces 104 may be included in a time-to-availability message.

In some configurations, the device host 106 may send the user interface status message 122 approximately when a status change occurs (e.g., preceding a status change, at a status change or following a status change). The status change may refer to a status change of a user interface 104 itself, a status change of the device host 106 or a combination of both. For example, when a display (or other user interface 104 such as a camera, fingerprint reader, touchscreen, etc.) is changing from an active state to an inactive state, the device host 106 may send a user interface status message 122 that indicates the change in state.

Additionally, when the device host 106 itself is about to change to an inactive state, the device host 106 may send a user interface status message 122 indicating that one or more of the user interfaces 104 that rely on the device host 106 may be unavailable. It should be noted that one or more of the user interfaces 104 (e.g., a wake button, a fingerprint reader, etc.) may be maintained active or semi-active while the device host 106 is in a reduced power state or an inactive state in some configurations. In such a case, the user interface status message 122 may indicate the availability of the user interface(s) 104 to the controller 108 during the reduced power or inactive state of the device host 106.

One or more of the secure elements 114 may send application information 124 to the controller 108. The application information 124 may identify one or more applications 126 provided by the one or more secure elements 114. In some configurations, the application information 124 may additionally specify one or more user interfaces 104 utilized by the one or more applications 126. In other words, the application information 124 may indicate that an application 126 requires the availability of one or more user interfaces 104 to operate. Additionally or alternatively, this user interface utilization information may be predetermined and stored by the controller 108.

The application information 124 may be sent directly to the controller 108 or may be sent to the controller 108 via the device host 106. For example, the device host 106 may receive the application information 124 from each secure element 114 and may send the application information 124 to the controller 108. For example, the device host 106 may read a PPSE from each secure element 114 and may send the application information 124 to the controller 108.

The controller 108 may include an application list determination module 110. The application list determination module 110 may be implemented in hardware and/or software. In some configurations, the application list determination module 110 may be a PPSE or may be included in a PPSE. The application list determination module 110 may determine the application list 112 based on the user interface status message(s) 122 and the application information 124. The application list 112 may be a list of applications 126 that are available for use. In one configuration, the application list 112 may be a file control information (FCI) block.

As described above, the availability of one or more applications 126 may be based on the availability of one or more user interfaces 104 utilized by the applications 126. It should be noted that some applications 126 may not utilize or may not require an available user interface 104. Furthermore, some applications 126 may allow only certain functions based on user interface 104 availability. For example, a credit card payment application 126 may allow small transactions (of $20 or less, for example) without an available user interface 104, but may require authentication (e.g., PIN, password, fingerprint scan, etc.) for larger transactions.

Determining the application list 112 may include listing one or more application indicators (e.g., application identifiers (AIDs)) corresponding to applications 126 that utilize a user interface 104 that is available or applications 126 that do not utilize a user interface 104. For example, the application list determination module 110 may add application indicators to the application list 112 corresponding to applications 126 that utilize one or more user interfaces 104 that are currently active and/or that can be activated within a threshold amount of time. In other words, if the one or more user interfaces 104 upon which an application 126 depends are available, then the application indicator corresponding to the application 126 may be added to the application list 112. Furthermore, the application list determination module 110 may add application indicators to the application list 112 corresponding to applications 126 that do not utilize a user interface 104.

Additionally or alternatively, the application list determination module 110 may determine the application list 112 by excluding one or more application indicators corresponding to applications 126 that utilize a user interface 104 that is unavailable. For example, the application list determination module 110 may exclude application indicators from the application list 112 corresponding to applications 126 that are completely non-functional because all of their functions require a user interface 104 that is unavailable or is available only after a threshold amount of time.

It should be noted that in some configurations, the application indicator corresponding to an application 126 may be included in the application list 112 if at least one of the application's 126 functions is operable. In other words, if at least one function does not require a user interface 104 or at least one function utilizes a user interface 104 that is available or is available within a threshold amount of time, then the application indicator corresponding to an application 126 may be included in the application list 112.

In some configurations, determining the application list 112 may be further based on a function context. In some configurations, the function context may be based on the transaction between the electronic device 102 and the remote device 118. In one example, an electronic device 102 is attempting to make a credit card payment of $25 and a user interface 104 utilized for authentication (e.g., touchscreen, keypad, etc.) is unavailable. In this scenario, a first application 126 allows non-authenticated transactions of $20 or less and only allows larger transactions with authentication. Additionally, a second application 126 allows non-authenticated transactions of $30 or less and only allows larger transactions with authentication. In this example, the function context is a transaction of $25. The controller 108 may add the second application 126 to the application list 112 because it allows the transaction to be completed even with the unavailable user interface 104. Furthermore, the controller 108 may exclude the first application 126 from the application list 112, even though the first application 126 allows smaller non-authenticated transactions, because the user interface 104 needed for authentication in this function context is unavailable.

The controller 108 may send the application list 112 to the remote device 118. For example, the controller 108 may send a message that indicates the application list 112 to the remote device 118 via the antenna 116. The remote device 118 may receive the application list 112 via an antenna 120 coupled to the remote device 118. In some configurations, when the electronic device 102 is brought into proximity with the remote device 118, the remote device 118 may send a message that requests information regarding enabled (e.g., available) applications 126. The controller 108 may respond by sending the application list 112.

Additionally or alternatively, the controller 108 may send a time-to-availability message that indicates a time-to-availability of one or more of the user interfaces 104. In some configurations, the time-to-availability message may be part of the application list 112. In other configurations, the time-to-availability message may be separate from the application list 112.

The systems and methods described herein may provide a controller 108 (e.g., NFC controller) that is aware of user interface 104 and/or device host 106 state(s). The systems and methods described herein may also enable sharing information about the capabilities (e.g., user interfaces 104) of an electronic device 102 and how quickly the capabilities can be available.

One benefit of the systems and methods disclosed herein is the ability to support multiple secure elements 114 in an electronic device 102 with a single PPSE. For example, incorporating additional functionality (e.g., a PPSE) into the controller 108 may allow listing applications 126 corresponding to multiple secure elements 114. Another benefit of the systems and methods described herein is enabling the controller 108 to perform power-efficient operations based on the availability of the user interface(s) 104 and/or the device host 106.

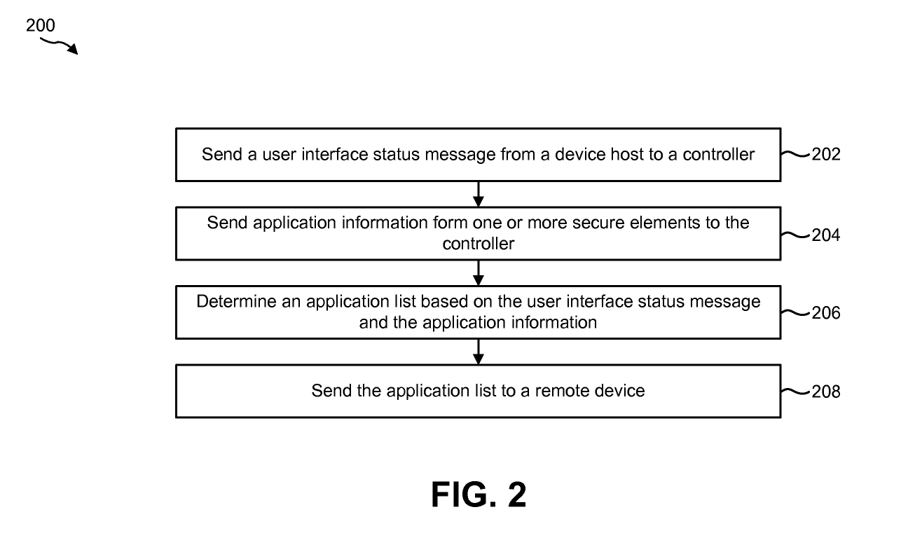

FIG. 2 is a flow diagram illustrating one configuration of a method 200 for reporting a user interface 104 status by an electronic device 102. The electronic device 102 may send 202 a user interface status message 122 from a device host 106 to a controller 108. This may be accomplished as described above in connection with FIG. 1. The user interface status message 122 may indicate an availability of one or more user interfaces 104. The user interface status message 122 may be sent 202 from the device host 106 to the controller 108 approximately when a status change occurs.

The electronic device 102 may send 204 application information 124 from one or more secure elements 114 to the controller 108. This may be accomplished as described above in connection with FIG. 1. The application information 124 may identify one or more applications 126 provided by the one or more secure elements 114. In some configurations, the application information 124 may additionally specify one or more user interfaces 104 utilized by the one or more applications 126.

The electronic device 102 may determine 206 an application list 112 based on the user interface status message 122 and the application information 124. This may be accomplished as described above in connection with FIG. 1. For example, determining 206 the application list 112 may include listing one or more application indicators corresponding to applications 126 that utilize a user interface 104 that is available. In one scenario, the application information 124 may indicate that an application 126 requires the availability of a user interface 104. Furthermore, in this scenario, the user interface status message 122 may indicate that the user interface 104 is available. Therefore, the electronic device 102 may add the application indicator of the application 126 to the application list 112.

Additionally or alternatively, the electronic device 102 may exclude one or more applications 126 that utilize a user interface 104 that is unavailable. In one configuration, the electronic device 102 may exclude (or remove) application indicators corresponding to applications 126 that utilize a user interface 104 that is not available. In one scenario, the application information 124 may indicate that an application 126 requires the availability of a user interface 104. However, in this scenario, the user interface status message 122 may indicate that the user interface 104 is not available. Therefore, the electronic device 102 may exclude (or remove) the application indicator of the application 126 from the application list 112.

The electronic device 102 may send 208 the application list 112 to a remote device 118. This may be accomplished as described above in connection with FIG. 1. In some configurations, the electronic device 102 may additionally send a time-to-availability message to the remote device 118. The time-to-availability message may be part of or separate from the application list 112. The time-to-availability message may be based on time-to-availability information provided by the device host 106 and/or based on predetermined time-to-availability information corresponding to the current user interface 104 status.

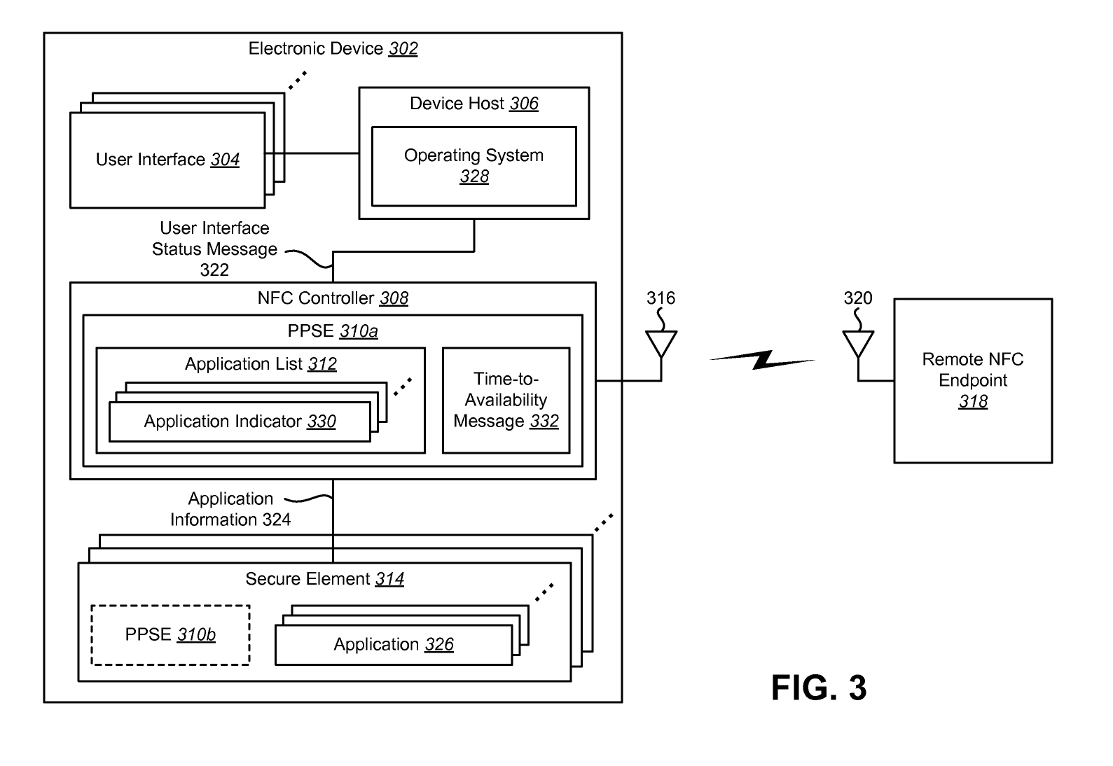

FIG. 3 is a block diagram illustrating a more specific configuration of an electronic device 302 in which systems and methods for reporting a user interface 304 status may be implemented. In particular, the electronic device 302 described in connection with FIG. 3 is a more specific example of the electronic device 102 described in connection with FIG. 1. Accordingly, the components included within the electronic device 302 described in connection with FIG. 3 may be examples of corresponding components described in connection with FIG. 1.

The electronic device 302 may include one or more user interfaces 304, a device host 306, an NFC controller 308 (coupled to an antenna 316) and one or more secure elements 314. Each of the one or more user interfaces 304 may be a device that enables a user to interact with the electronic device 302 as described above.

In this example, the device host 306 includes an operating system 328. Examples of operating systems 328 that may be run by the device host 306 include Android, iOS, Windows Phone, Windows RT and Blackberry.

The NFC controller 308 may be coupled to the device host 306. The NFC controller 308 may include an induction-based communication transceiver, which may establish radio communication with a remote NFC endpoint 318 using magnetic induction. The induction-based communication transceiver may include an induction-based transmitter and a receiver.

The NFC controller 308 may include a PPSE 310a. The PPSE 310a may be a program, software or instructions that may be run by the NFC controller 308 in order to perform one or more functions (e.g., to perform credit card transactions, etc.).

The NFC controller 308 may also be coupled to one or more secure elements 314. Each of the secure elements 314 may include one or more applications 326. The applications 326 may perform one or more functions when executed, as described above. For example, the applications 326 may enable certain transactions or functions (e.g., debit card payments, credit card payments, authentication, etc.) with the remote NFC endpoint 318.

The device host 306 may send a user interface status message 322 to the NFC controller 308. The PPSE 310a may receive and/or update the user interface status message 322. In some configurations, the user interface status message 322 may also indicate a time-to-availability for one or more of the user interfaces 304. The PPSE 310a may receive, store and/or update the time-to-availability for the one or more user interfaces 304.

One or more of the secure elements 314 may send application information 324 to the NFC controller 308. The application information 324 may identify one or more applications 326 provided by the one or more secure elements 314. In some configurations, the application information 324 may additionally specify one or more user interfaces 304 utilized by the one or more applications 326. In other words, the application information 324 may indicate that an application 326 requires the availability of one or more user interfaces 304 to operate. Additionally or alternatively, this user interface utilization information may be predetermined and stored by the controller 308.

The PPSE 310a of the NFC controller 308 may determine an application list 312 based on the user interface status message(s) 322 and the application information 324. The application list 312 may be a list of applications 326 that are available for use. The availability of one or more applications 326 may be based on the availability of one or more user interfaces 304 utilized by the applications 326. It should be noted that some applications 326 may not utilize or may not require an available user interface 304. Furthermore, some applications 326 may allow only certain functions based on user interface 304 availability.

The PPSE 310a may include one or more application indicators (e.g., application identifiers (AIDs)) corresponding to applications 326 that utilize a user interface 304 that is available or applications 326 that do not utilize a user interface 304. For example, the PPSE 310a may add application indicators 330 to the application list 312 corresponding to applications 326 that utilize one or more user interfaces 304 that are currently active and/or that can be activated within a threshold amount of time. Therefore, if the one or more user interfaces 304 upon which an application 326 depends are available, then the application indicator 330 corresponding to the application 326 may be added to the application list 312. Furthermore, the PPSE 310a may add application indicators 330 to the application list 312 corresponding to applications 326 that do not utilize a user interface 304.

Additionally or alternatively, the PPSE 310a may determine the application list 312 by excluding one or more application indicators 330 corresponding to applications 326 that utilize a user interface 304 that is unavailable. For example, the PPSE 310a may exclude application indicators 330 from the application list 312 corresponding to applications 326 that are completely non-functional because all of their functions require a user interface 304 that is unavailable or is available only after a threshold amount of time.

It should be noted that in some configurations, the application indicator 330 corresponding to an application 326 may be included in the application list 312 if at least one of the application's 326 functions is operable. In other words, if at least one function does not require a user interface 304 or at least one function utilizes a user interface 304 that is available or is available within a threshold amount of time, then the application indicator 330 corresponding to an application 326 may be included in the application list 312.

It should be noted that one or more of the secure elements 314 may optionally include a PPSE 310b (in addition to the PPSE 310a of the NFC controller 308). In the systems and methods described herein, the functionality of the PPSE 310b located on the secure element 314 may be incorporated into the PPSE 310a included in the NFC controller 308.

In another configuration, for an electronic device 302 that does not host an entire PPSE 310a on the NFC controller 308 or where legacy secure elements 314 are used that do not support an external PPSE 310a, each of the one or more secure elements 314 may include a PPSE 310b that determine the application list 312. However, the NFC controller 308 may update the application list 312 to indicate user interface 304 availability. For example, the NFC controller 308 may produce an application list 312 by updating the specific bits produced by a secure element 314 PPSE 310b that relate to user interface 304 availability when reporting to a remote NFC endpoint 318. In other words, the NFC controller 308 may modify an application list 312 produced by a secure element 314 to report only available applications 326 (e.g., applications 326 that have available user interfaces 304 or do not require an available user interface 304).

The NFC controller 308 may send the application list 312 to the remote NFC endpoint 318. The remote NFC endpoint 318 may receive the application list 312 via an antenna 320 coupled to the remote NFC endpoint 318. Additionally or alternatively, the NFC controller 308 may send a time-to-availability message 332 (to the remote NFC endpoint 318) that indicates a time-to-availability of one or more of the user interfaces 304. In some configurations, the time-to-availability message 332 may be part of or separate from the application list 312.

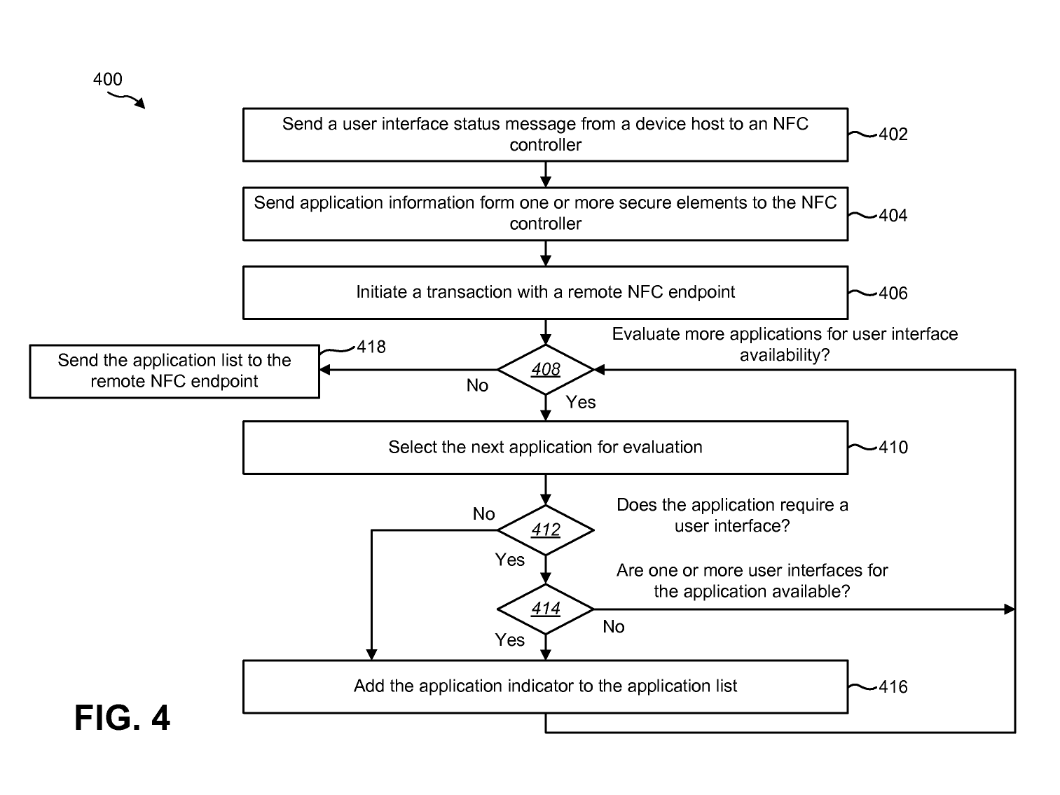

FIG. 4 is a flow diagram illustrating another configuration of a method 400 for reporting a user interface 304 status by an electronic device 302. The electronic device 302 may send 402 a user interface status message 322 from a device host 306 to an NFC controller 308. This may be accomplished as described above in connection with FIG. 3. The user interface status message 322 may indicate an availability of one or more user interfaces 304. The user interface status message 322 may be sent 402 from the device host 306 to the NFC controller 308 approximately when a status change occurs.

The electronic device 302 may send 404 application information 324 from one or more secure elements 314 to the NFC controller 308. This may be accomplished as described above in connection with FIG. 3. The application information 324 may identify one or more applications 326 provided by the one or more secure elements 314. In some configurations, the application information 324 may additionally specify one or more user interfaces 304 utilized by the one or more applications 326.

The electronic device 302 may initiate 406 a transaction with a remote NFC endpoint 318. In some configurations, when the electronic device 302 is brought into proximity with the remote NFC endpoint 318, the NFC controller 308 may establish an NFC communication link with the remote NFC endpoint 318. The electronic device 302 and the remote NFC endpoint 318 may initiate 406 a transaction. For example, the transaction may include a credit card payment transaction. The remote NFC endpoint 318 may send a message to the electronic device 302 that requests information regarding enabled (e.g., available) applications 326.

The electronic device 302 may determine 408 whether to evaluate one or more applications 326 for user interface 304 availability. For example, the electronic device 302 may assign an index value to each application 326 that is included in the application information 324. If there is at least one application 326 that is to be evaluated (e.g., one or more applications 326 are assigned an index value), then the electronic device 302 may evaluate the applications 326 for availability. The electronic device 302 may select 410 the next application 326 for evaluation.

The electronic device 302 may determine 412 whether the application 326 requires one or more user interfaces 304. For example, starting with the first application 326 from the application information 324 (e.g., the first index value), the electronic device 302 may determine 412 whether the application requires one or more user interfaces 304 based on the application information 324. If the application 326 does not require a user interface 304, then the electronic device 302 may add 416 an application indicator 330 corresponding to applications 326 to the application list 312.

If the electronic device 302 determines 412 that the application 326 requires one or more user interfaces 304, then the electronic device 302 may determine 414 whether one or more user interfaces 304 for the application 326 are available. The electronic device 302 may determine 414 whether the one or more required user interfaces 304 are available based on the user interface status message 322. If one or more of the user interfaces 304 that are required for the application 326 are available, then the electronic device 302 may add 416 the application indicator 330 corresponding to applications 326 to the application list 312. Upon adding 416 the application indicator 330, the electronic device 302 may determine 408 whether to evaluate more applications 326 (e.g., whether each application index value has been evaluated). If the electronic device 302 determines 414 that one or more user interfaces 304 are not available for the application 326, the electronic device 302 may exclude the application 326 from the application list 312 and may determine 408 whether to evaluate more applications 326 for user interface 304 availability.

If the electronic device 302 determines 408 that there are no more applications 326 to evaluate for user interface 304 availability, then the electronic device 302 may send 418 the application list 312 to the remote NFC endpoint 318. This may be accomplished as described above in connection with FIG. 3. In some configurations, the electronic device 302 may additionally send a time-to-availability message 332 to the remote NFC endpoint 318. The time-to-availability message may be part of or separate from the application list 312. The time-to-availability message may be based on time-to-availability information provided by the device host 306 and/or based on predetermined time-to-availability information corresponding to user interface 304 time-to-availability corresponding to the current user interface 304 status.

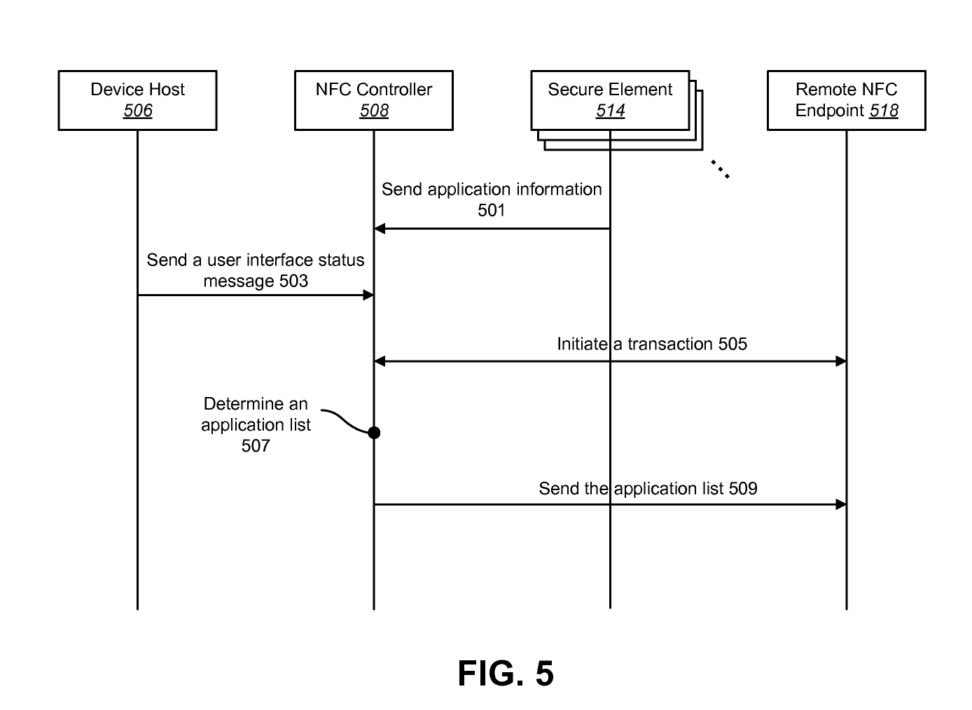

FIG. 5 is a thread diagram illustrating one configuration of timing for reporting a user interface 304 status. In one configuration, an electronic device 302 may include a device host 506, an NFC controller 508 and one or more secure elements 514, as described above in connection with FIG. 3.

The one or more secure elements 514 may send 501 application information 324 to the NFC controller 508. The application information 324 may identify one or more applications 326 provided by the one or more secure elements 514. In some configurations, the application information 324 may additionally specify one or more user interfaces 304 utilized by the one or more applications 326.

The device host 506 may send 503 a user interface status message 322 to the NFC controller 308. The user interface status message 322 may indicate the availability of one or more user interfaces 304. The NFC controller 308 may maintain one or more user interface 304 state indicators in memory (e.g., in a cache). In some configurations, the device host 506 may send 503 the user interface status message 322 approximately when a status change occurs (e.g., preceding a status change, at a status change or following a status change). The status change may refer to a status change of a user interface 304 itself, a status change of the device host 506 or a combination of both. Additionally, when the device host 506 itself is about to change to an inactive state, the device host 506 may send 503 a user interface status message 322 indicating that one or more of the user interfaces 304 that rely on the device host 506 may be unavailable.

The NFC controller 508 may initiate 505 a transaction with a remote NFC endpoint 518. The NFC controller 508 may establish an NFC communication link with the remote NFC endpoint 518. The remote NFC endpoint 518 may request information from the NFC controller 508 regarding enabled (e.g., available) applications 326.

The NFC controller 508 may determine 507 an application list 312. This may be accomplished as described in connection with FIG. 3. For example, the NFC controller 508 may determine 507 an application list 312 based on the user interface status message(s) 322 and the application information 324. The application list 312 may be a list of applications 326 that are available for use. The availability of one or more applications 326 may be based on the availability of one or more user interfaces 304 utilized by the applications 326. It should be noted that some applications 326 may not utilize or may not require an available user interface 304. Furthermore, some applications 326 may allow only certain functions based on user interface 304 availability.

The NFC controller 508 may send 509 the application list 312 to the remote NFC endpoint 518. This may be accomplished as described in connection with FIG. 3. The application list 312 may indicate to the remote NFC endpoint 518 that zero, one or more applications 326 have available user interfaces 304 or do not require a user interface 304.

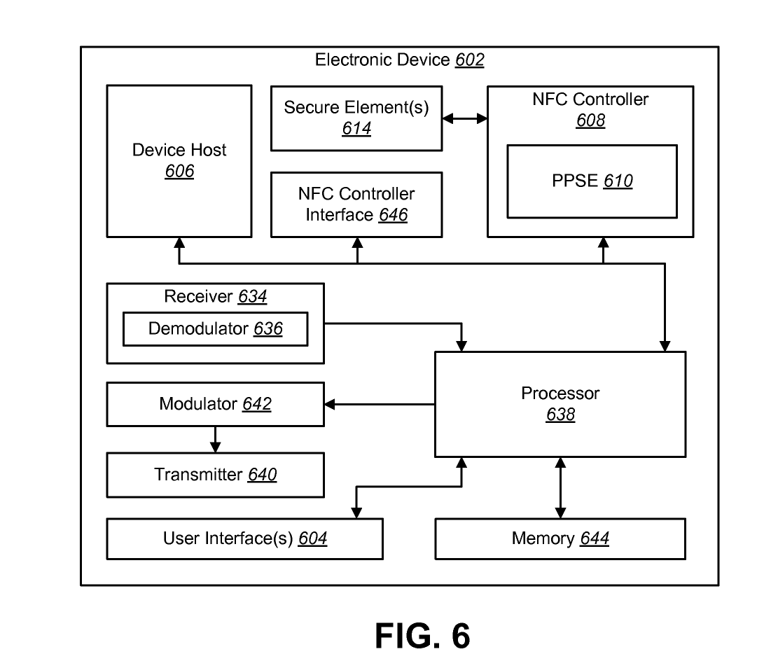

FIG. 6 is a block diagram illustrating another more specific configuration of an electronic device 602 in which systems and methods for reporting a user interface 604 status may be implemented. The components included within the electronic device 602 may be examples of corresponding components described above in connection with one or more of FIGS. 1 and 3.

As depicted in FIG. 6, the electronic device 602 includes a receiver 634 that receives a signal from, for instance, a receive antenna (not shown), performs typical actions on (e.g., filters, amplifies, downconverts, etc.) the received signal, and digitizes the conditioned signal to obtain samples. The receiver 634 can comprise a demodulator 636 that can demodulate received symbols and provide them to a processor 638 for channel estimation. The processor 638 can be a processor dedicated to analyzing information received by the receiver 634 and/or generating information for transmission by the transmitter 640, a processor that controls one or more components of the electronic device 602, and/or a processor that analyzes information received by the receiver 634, generates information for transmission by the transmitter 640 and controls one or more components of the electronic device 602. Further, signals may be prepared for transmission by the transmitter 640 through the modulator 642, which may modulate the signals processed by the processor 638.

The electronic device 602 can additionally comprise memory 644 that is operatively coupled to the processor 638 and that can store data to be transmitted, received data, information related to available channels, transmission control protocol (TCP) flows, data associated with analyzed signal and/or interference strength, information related to an assigned channel, power, rate or the like, and any other suitable information for estimating a channel and communicating via the channel.

Further, the processor 638, receiver 634, transmitter 640, NFC controller 608, and/or the device host 606 may perform one or more of the functions described above in connection with FIGS. 1-5. It will be appreciated that the data store (e.g., memory 644) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 644 of the subject systems and methods may comprise, without being limited to, these and any other suitable types of memory.

In another aspect, the electronic device 602 may include an NFC controller interface (NCI) 646. In an aspect, the NCI 646 may be operable to enable communications between the device host 606 and the NFC controller 608.

The electronic device 602 may include an NFC controller 608. The NFC controller 608 may include one or more proximity payment system environment (PPSE) 610. The NFC controller 608 may communicate with one or more secure elements 614.

In an aspect, the NFC controller 608 may be operable to obtain, through the NCI 646, information from other devices, such as a remote NFC endpoint 318. During ISO-DEP communication, the NFC controller 608 may operate using a frame RF interface or an ISO-DEP interface. When operating using the ISO-DEP interface, the NFC controller 608 may be operable to change various parameters associated with communications between the device host 606 and the remote NFC endpoint 318 using a data exchange change module.

In some configurations, the NFC controller 608 may act as a relay and communicate messages between the device host 606 and a remote NFC endpoint 318. For example, the device host 606 may extract data from messages exchanged with the remote NFC endpoint 318. Communications may prompt the NFC controller 608 to change various data. The NFC controller 608 may update received parameters and/or may store parameters in memory.

Additionally, the electronic device 602 may include one or more user interfaces 604. The user interface(s) 604 may include input mechanism(s) for generating inputs into the electronic device 602 and/or output mechanism(s) for generating information for consumption by the user of the electronic device 602. For example, input mechanism(s) may include a mechanism such as a key or keyboard, a mouse, a touch-screen display, a microphone, etc. Further, for example, output mechanism(s) may include a display, an audio speaker, a haptic feedback mechanism, a Personal Area Network (PAN) transceiver etc. In the illustrated aspects, the output mechanism may include a display operable to present media content that is in image or video format or an audio speaker to present media content that is in an audio format.

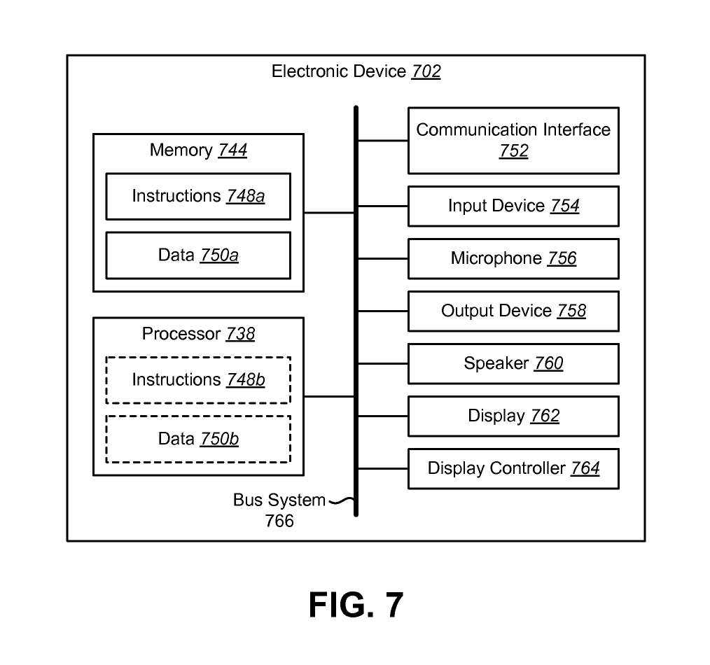

FIG. 7 illustrates various components that may be utilized in an electronic device 702. The illustrated components may be located within the same physical structure or in separate housings or structures. The electronic device 702 described in connection with FIG. 7 may be implemented in accordance with one or more of the electronic devices 102, 302, 602 described herein.

The electronic device 702 includes a processor 738. The processor 738 may be a general purpose single- or multi-chip microprocessor (e.g., an ARM), a special purpose microprocessor (e.g., a digital signal processor (DSP)), a microcontroller, a programmable gate array, etc. The processor 738 may be referred to as a central processing unit (CPU). Although just a single processor 738 is shown in the electronic device 702 of FIG. 7, in an alternative configuration, a combination of processors 738 (e.g., an ARM and DSP) could be used.

The electronic device 702 also includes memory 744 in electronic communication with the processor 738. That is, the processor 738 can read information from and/or write information to the memory 744. The memory 744 may be any electronic component capable of storing electronic information. The memory 744 may be random access memory (RAM), read-only memory (ROM), magnetic disk storage media, optical storage media, flash memory devices in RAM, on-board memory included with the processor 738, programmable read-only memory (PROM), erasable programmable read-only memory (EPROM), electrically erasable PROM (EEPROM), registers, and so forth, including combinations thereof.

Instructions 748a and data 750a may be stored in the memory 744. The instructions 748a may include one or more programs, routines, sub-routines, functions, procedures, etc. The instructions 748a may include a single computer-readable statement or many computer-readable statements. The instructions 748a may be executable by the processor 738 to implement one or more of the methods, functions and procedures described above. Executing the instructions 748a may involve the use of the data 750a that is stored in the memory 744. FIG. 7 shows some instructions 748b and data 750b being loaded into the processor 738 (which may come from instructions 748a and data 750a that are stored in the memory 744).

The electronic device 702 may also include one or more communication interfaces 752 for communicating with other electronic devices. The communication interfaces 752 may be based on wired communication technology, wireless communication technology or both. Examples of different types of communication interfaces 752 include a serial port, a parallel port, a Universal Serial Bus (USB), an Ethernet adapter, an Institute of Electrical and Electronics Engineers (IEEE) 1394 bus interface, a near-field communication (NFC) transceiver, a small computer system interface (SCSI) bus interface, an infrared (IR) communication port, a Bluetooth wireless communication adapter, a 3rd Generation Partnership Project (3GPP) transceiver, an IEEE 802.11 (“Wi-Fi”) transceiver and so forth. For example, the communication interface 752 may be coupled to one or more antennas (not shown) for transmitting and receiving wireless signals.

The electronic device 702 may also include one or more input devices 754 and one or more output devices 758. Examples of different kinds of input devices 754 include a keyboard, mouse, microphone 756, remote control device, button, joystick, trackball, touchpad, lightpen, etc. For instance, the electronic device 702 may include one or more microphones 756 for capturing acoustic signals. In one configuration, a microphone 756 may be a transducer that converts acoustic signals (e.g., voice, speech) into electrical or electronic signals. Examples of different kinds of output devices 758 include a speaker 760, printer, etc. For instance, the electronic device 702 may include one or more speakers 760. In one configuration, a speaker 760 may be a transducer that converts electrical or electronic signals into acoustic signals. One specific type of output device 758 that may be typically included in an electronic device 702 is a display 762 device. Display 762 devices used with configurations disclosed herein may utilize any suitable image projection technology, such as a cathode ray tube (CRT), liquid crystal display (LCD), light-emitting diode (LED), gas plasma, electroluminescence, or the like. A display controller 764 may also be provided, for converting data stored in the memory 744 into text, graphics, and/or moving images (as appropriate) shown on the display 762 device.

The various components of the electronic device 702 may be coupled together by one or more buses, which may include a power bus, a control signal bus, a status signal bus, a data bus, etc. For simplicity, the various buses are illustrated in FIG. 7 as a bus system 766. It should be noted that FIG. 7 illustrates only one possible configuration of an electronic device 702. Various other architectures and components may be utilized.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-Ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for reporting a user interface status by an electronic device, comprising:
sending a user interface status message from a device host to a controller, wherein the user interface status message indicates an availability of one or more user interfaces, wherein availability corresponds to a powered state;
sending application information from one or more secure elements to the controller;
determining an application list based on the user interface status message and the application information; and
sending the application list to a remote device.

2. The method of claim 1, wherein determining the application list comprises listing one or more application indicators corresponding to applications that utilize a user interface that is available.

3. The method of claim 1, wherein determining the application list comprises excluding one or more application indicators corresponding to applications that utilize a user interface that is unavailable.

4. The method of claim 1, further comprising sending a time-to-availability message that indicates a time-to-availability of one or more user interfaces to the remote device.

5. The method of claim 1, wherein the user interface status message is sent from the device host to the controller when a status change of the one or more user interfaces occurs.

6. The method of claim 1, wherein the controller is a near-field communication (NFC) controller that includes a proximity payment system environment (PPSE).

7. The method of claim 6, wherein the PPSE of the NFC controller determines the application list.

8. The method of claim 1, wherein each of the one or more secure elements include a proximity payment system environment (PPSE) that determine an application list, and wherein the controller updates the application list to indicate user interface availability.

9. An electronic device for reporting a user interface status, comprising:
a device host that sends a user interface status message, wherein the user interface status message indicates an availability of one or more user interfaces, wherein availability corresponds to a powered state;
at least one secure element that sends application information; and
a controller coupled to the device host and to the at least one secure element, wherein the controller:
receives the user interface status message from the device host;
receives the application information from the at least one secure element;
determines an application list based on the user interface status message and the application information; and
sends the application list to a remote device.

10. The electronic device of claim 9, wherein determining the application list comprises listing one or more application indicators corresponding to applications that utilize a user interface that is available.

11. The electronic device of claim 9, wherein determining the application list comprises excluding one or more application indicators corresponding to applications that utilize a user interface that is unavailable.

12. The electronic device of claim 9, further comprising sending a time-to-availability message that indicates a time-to-availability of one or more user interfaces to the remote device.

13. The electronic device of claim 9, wherein the user interface status message is sent from the device host to the controller when a status change of the one or more user interfaces occurs.

14. The electronic device of claim 9, wherein the controller is a near-field communication (NFC) controller that includes a proximity payment system environment (PPSE).

15. The electronic device of claim 14, wherein the PPSE of the NFC controller determines the application list.

16. The electronic device of claim 9, wherein each of the one or more secure elements include a proximity payment system environment (PPSE) that determine the application list, and wherein the controller updates the application list to indicate user interface availability.

17. A computer-program product for reporting a user interface status, comprising a non-transitory tangible computer-readable medium having instructions thereon, the instructions comprising:
code for causing an electronic device to send a user interface status message from a device host to a controller, wherein the user interface status message indicates an availability of one or more user interfaces, wherein availability corresponds to a powered state;
code for causing the electronic device to send application information from one or more secure elements to the controller;
code for causing the electronic device to determine an application list based on the user interface status message and the application information; and
code for causing the electronic device to send the application list to a remote device.

18. The computer-program product of claim 17, wherein the code for causing the electronic device to determine the application list comprises code for causing the electronic device to list one or more application indicators corresponding to applications that utilize a user interface that is available.

19. The computer-program product of claim 17, wherein the code for causing the electronic device to determine the application list comprises code for causing the electronic device to exclude one or more application indicators corresponding to applications that utilize a user interface that is unavailable.

20. The computer-program product of claim 17, further comprising code for causing the electronic device to send a time-to-availability message that indicates a time-to-availability of one or more user interfaces to the remote device.

21. The computer-program product of claim 17, wherein the user interface status message is sent from the device host to the controller when a status change of the one or more user interfaces occurs.

22. The computer-program product of claim 17, wherein the controller is a near-field communication (NFC) controller that includes a proximity payment system environment (PPSE).

23. The computer-program product of claim 22, wherein the PPSE of the NFC controller determines the application list.

24. An apparatus for reporting a user interface status, comprising:
means for sending a user interface status message from a device host to a controller, wherein the user interface status message indicates an availability of one or more user interfaces, wherein availability corresponds to a powered state;
means for sending application information from one or more secure elements to the controller;
means for determining an application list based on the user interface status message and the application information; and
means for sending the application list to a remote device.

25. The apparatus of claim 24, wherein the means for determining the application list comprise means for listing one or more application indicators corresponding to applications that utilize a user interface that is available.

26. The apparatus of claim 24, wherein the means for determining the application list comprise means for excluding one or more application indicators corresponding to applications that utilize a user interface that is unavailable.

27. The apparatus of claim 24, further comprising means for sending a time-to-availability message that indicates a time-to-availability of one or more user interfaces to the remote device.

28. The apparatus of claim 24, wherein the user interface status message is sent from the device host to the controller when a status change of the one or more user interfaces occurs.

29. The apparatus of claim 24, wherein the controller is a near-field communication (NFC) controller that includes a proximity payment system environment (PPSE).

30. The apparatus of claim 29, wherein the PPSE of the NFC controller determines the application list.
